(19) United States
(12) Patent Application Publication
(10) Pub. No.: US 2002/0083091 A1
(43) Pub. Date: Jun. 27, 2002

(54) Seamless integration of video on a background object

(76) Inventors: Gregory Pulier, Los Angeles, CA (US); John David Busfield, Valencia, CA (US)

Correspondence Address: Jones, Day, Reavis and Pogue, North Point, 901 Lakeside Avenue, Cleveland, OH, 44114, US

(21) Appl. No.: 09/996,356

(22) Filed: Nov. 29, 2001

Related U.S. Application Data
(60) Provisional application No. 60/253,921, filed on Nov. 29, 2000.

(51) Int. Cl. G06F 15/00

(52) U.S. Cl. 707/501.1

(57) ABSTRACT

A computer-implemented method and system for integrating video data with a document object that includes document elements. The video data is synchronized with at least one of the document elements so as to form at least one synchronization association. The synchronization association interrelates an activity of the video data with an activity of the document object. A synchronization file is generated that includes the synchronization association. The synchronization file is associated with the video data so that the activity involving the video data appears on a computer-human display as integrated with the document object.

### RELATED APPLICATION

This application claims priority to U.S. provisional application serial no. 60/253,921 entitled “Seamless Integration of Video on a Background Object” filed Nov. 29, 2000. By this reference, the full disclosure, including the drawings, of U.S. provisional application Serial No. 60/253,921 is incorporated herein.

### BACKGROUND

1. Technical Field

The present invention is directed to the field of multi-media documents and presentations. More specifically, the invention provides a way of seamlessly integrating a video object onto a virtual or real background object.

2. Description of the Related Art

It is quite common today to have a video clip integrated into a document object, such as a web page. These document objects, however, typically display the video in a separate window associated with a particular media player, and make no attempt to integrate the video images into the background or other parts of the document object. This lack of integration has limited the creativity and usefulness of video in the context of such document objects.

### SUMMARY

A computer-implemented method and system are provided for integrating video data with a document object that includes document elements. The video data is synchronized with at least one of the document elements so as to form at least one synchronization association. The synchronization association interrelates an activity of the video data with an activity of the document object. A synchronization file is generated that includes the synchronization association. The synchronization file is associated with the video data so that the activity involving the video data appears on a computer-human display as integrated with the document object.

### BRIEF DESCRIPTION OF THE DRAWINGS

FIG. 1 is a block diagram depicting software and computer components used in integrating a video clip into a web page;

FIGS. 2-4 are flow charts depicting a series of steps for integrating a video clip into a virtual web page background;

FIGS. 5-7 are flow charts depicting a series of steps for integrating a video clip into a real web page background; and

FIG. 8 is a block diagram depicting software and computer components for providing integrated video clips tailored to client computer configurations.

### DETAILED DESCRIPTION

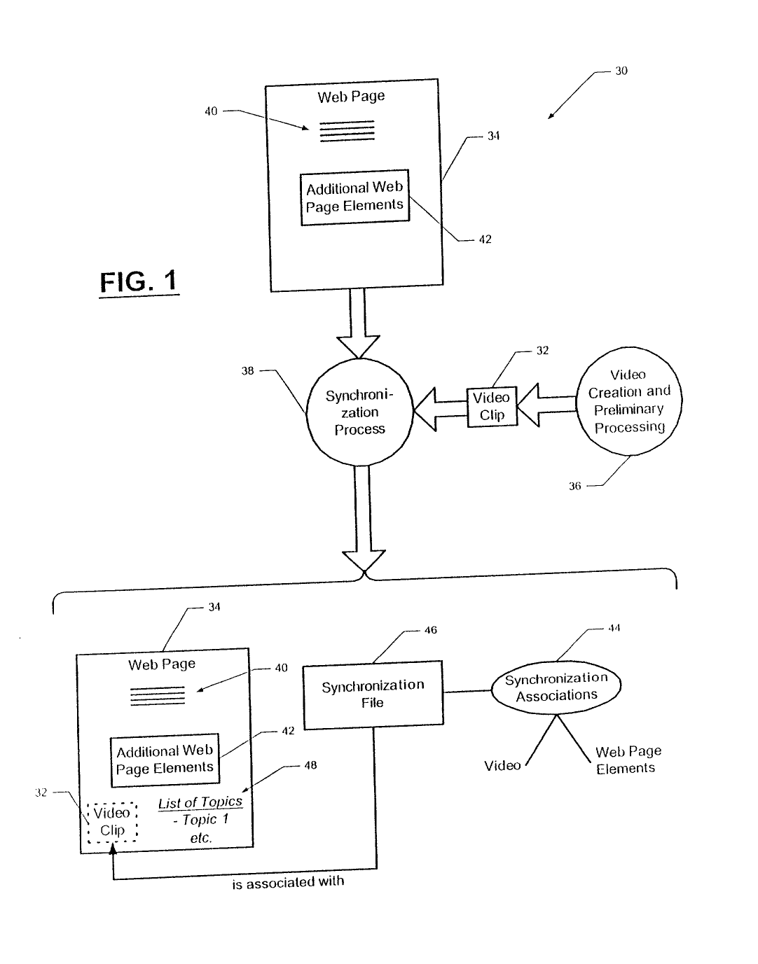

FIG. 1 depicts at 30 a video integration system for use in the creation and processing of a video clip 32 and its subsequent incorporation into a web page 34 (or other document object). The video integration system 30 allows the video clip 32 to seamlessly appear on the web page 34—thus allowing, for example, a video clip of a person to be walking around in, sitting in, and to be talking about and pointing to text or objects in a virtual or real web page background. An example of a virtual web page background would be a computer-generated background, such as a drawing file. An example of a real web page background would be a photographic image, such as a JPG, GIF, or other type of image file that represents a real background environment. Such an integrated video with a web page is accessible over any computer network, such as over an Internet connection.

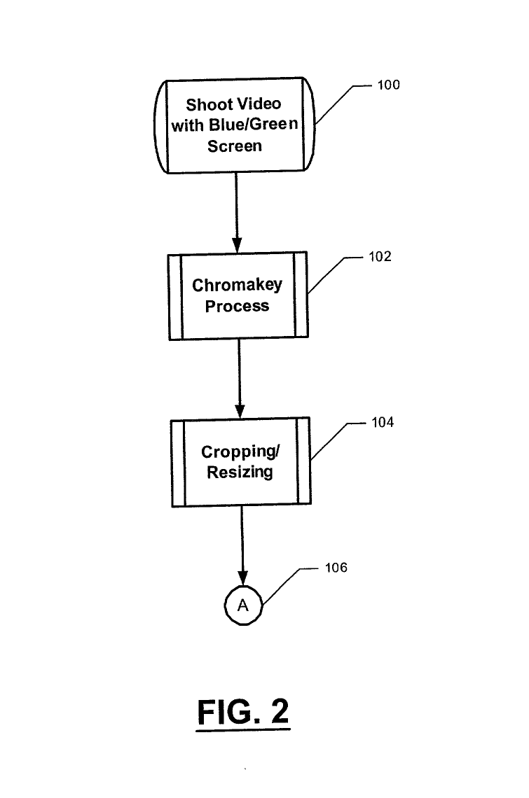

As shown at reference numeral 36, the video clip 32 is created and preprocessed as video data before it is integrated with the web page 34. The preprocessing of the video data 32 may include running the video data 32 through a standard chromakey process in order to remove a colored screen background and replace it with the web page's background. Preprocessing may also include the video data being cropped and resized to make it more reasonable to stream and to fit onto the web page (note that additional preprocessing may occur and is discussed in greater detail in FIGS. 2-4).

The preprocessed video data 32 is sent to a synchronization process 38 so that the video data 32 may be integrated with the web page 34. The web page 34 may contain web page elements, such as selectable lines of text 40 as well as other types of web page elements 42. A web page designer specifies which web page elements are to be synchronized with what aspects of the video data 32. For example, the web page designer may specify that at a certain time during playing of the video a preselected set of text is to appear seamlessly alongside the playing video.

The synchronization process 38 synchronizes the video data 32 with at least one of the web page elements so as to form one or more synchronization associations 44. The synchronization associations 44 interrelate activities of the video data 32 (e.g., video data at a preselected play time, etc.) with activities of the web page 34 (e.g., displaying of text, a user selecting a line of text, etc.). A synchronization file 46 is generated that includes the synchronization associations 44. The synchronization file 46 is then associated with the video data 32 so that the activity involving the video data appears on a computer-human display as integrated, seamless and interactive as any other web element (e.g., text, graphics, etc.).

The video integration system 30 allows video to be integrated into a web page in such a way that any extraneous background, particularly the media player running the video, is hidden from view. Also, the video 32 may be a fully interactive element on the web page 34 in that it can both be triggered by events on the web page 34 (such as a user selecting a line of text 40) and can trigger web page events to happen (such as when video 32 of a person says it's time to select a topic, the choice of topics 48 is displayed on the web page 34).

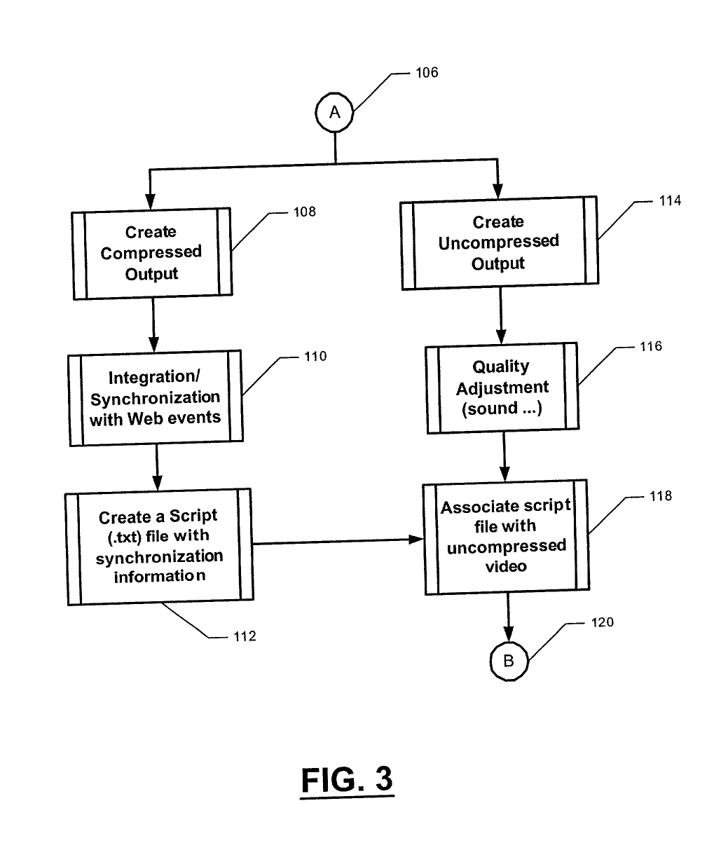

FIGS. 2-4 depict a process flow for integrating video onto a web page with a virtual background (i.e., the background of the web page on which the video appears is not the background/environment in which the video was shot). With reference to step 100 of FIG. 2, video of the person, or whatever video element that is to appear on the web page, is shot against a blue or green screen. The video is sent through a standard chromakey process at step 102 to remove the blue or green screen background and replace it with the web page background (solid color or a graphic). The video figure, or key element, is cropped and resized at step 104 to make it reasonable to stream and to fit onto the web page (e.g. average of 200 pixels high). Processing continues on FIG. 3 as shown by continuation indicator 106.

With reference to step 108 of FIG. 3, a compressed version of the video file is created to make it less cumbersome for programmers and designers to work with when they integrate it into web pages. The video is integrated into the web page and synchronized at step 110 with the other web page elements, using some process such as IVT's Synclt program. IVT (Interactive Video Technologies) is located in New York. IVT's Synclt program is described in co-pending U.S. patent application Serial No. 09/324,389 entitled “System, Method and Article for Applying temporal elements to the attributes of a static document object,” the disclosure and teaching of which are hereby incorporated herein by reference. With reference to step 112, a script file (.txt) with all the synchronization information associated with the video is output at the end of the web page synchronization process.

An uncompressed version of the video file is created at step 114 for higher quality, final output purposes. Any needed adjustments to quality, such as sound, are made at step 116 (this may be done while the compressed version is being integrated/synchronized). Steps 114 and 116 may be performed sequentially or in parallel with steps 108, 110, and 112.

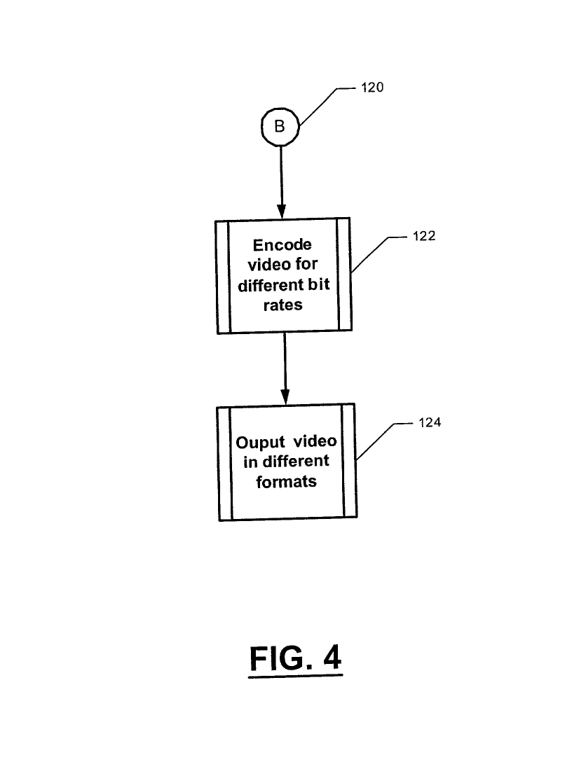

At step 118, the script file with synchronization information (as generated at step 112) is associated with the uncompressed video file (as generated at step 116), such that the synchronization information becomes part of the video file (e.g., by use of ASF Indexer where ASF stands for “Advanced Streaming Format”). Processing continues on FIG. 4 as shown by continuation indicator 120.

With reference to step 122 of FIG. 4, the final video file (uncompressed and with synchronization information) is encoded for different bit rates (56K, 120K, etc.). The final video file is output at step 124 in different formats (for Windows Media Player, Real Player, QuickTime, etc.).

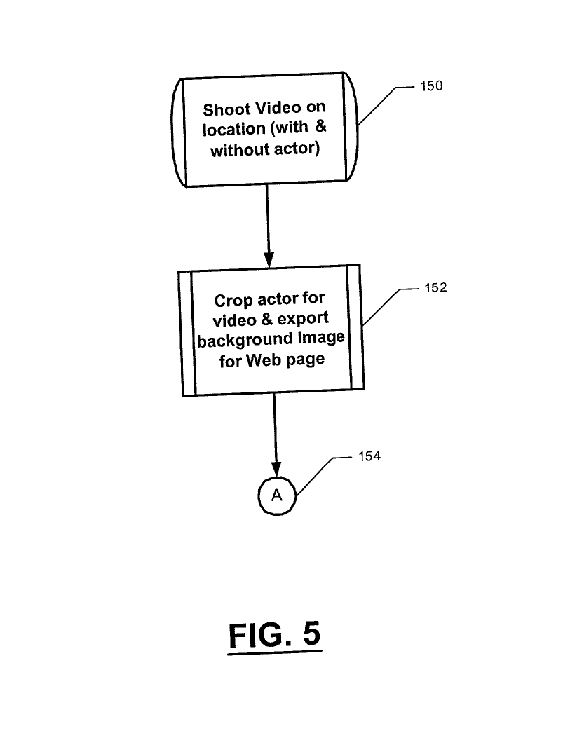

FIGS. 5-7 depict a process flow for integrating video onto a web page with a real background (i.e., the background of the web page on which the video appears is the same as the background/environment in which the video was shot).

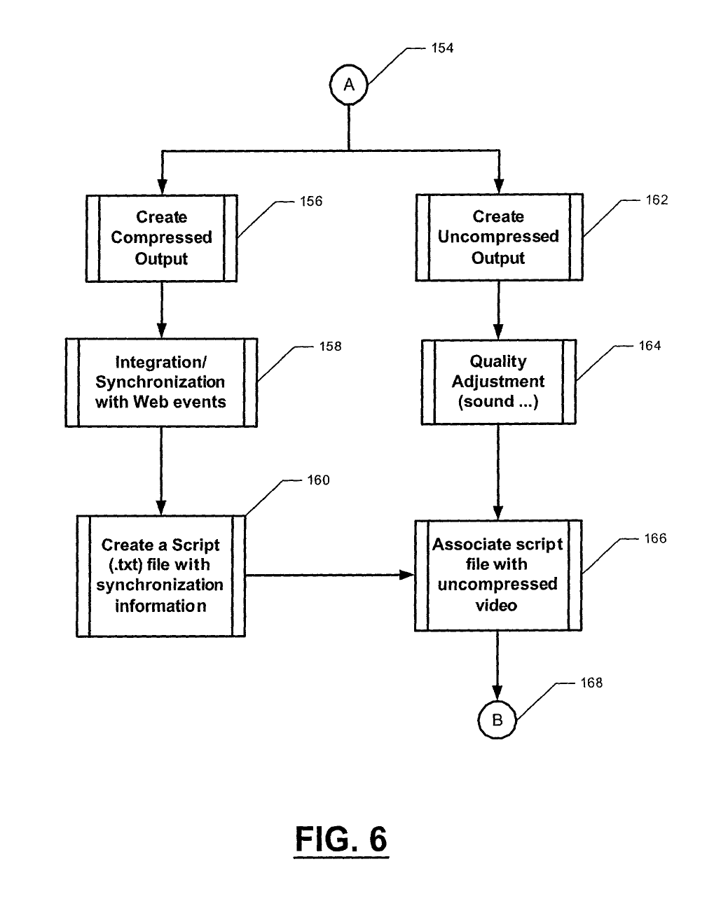

With reference to step 150 of FIG. 5, video is shot on location—with and without the actor in the scene. The video figure, or key element, is cropped and resized at step 152 to make it reasonable to stream and to fit onto the web page (average of 200 pixels high). The background of the video is exported as an image for use as the web page background. Processing continues on FIG. 6 as shown by continuation indicator 154.

With reference to step 156 of FIG. 6, a compressed version of the video file is created to make it less cumbersome for programmers and designers to work with when they integrate it into web pages. At step 158, the video is integrated into the web page and synchronized with the other web page elements, using some process such as IVT's Synclt program. At step 160, a script file (.txt) with all the synchronization information associated with the video is output at the end of the web page synchronization process.

An uncompressed version of the video file is created at step 162 for higher quality, final output purposes. Any needed adjustments to quality, such as sound, are made at step 162 (this can be done while the compressed version is being integrated/synchronized). Steps 162 and 164 may be done sequentially or in parallel with steps 156, 158, and 160.

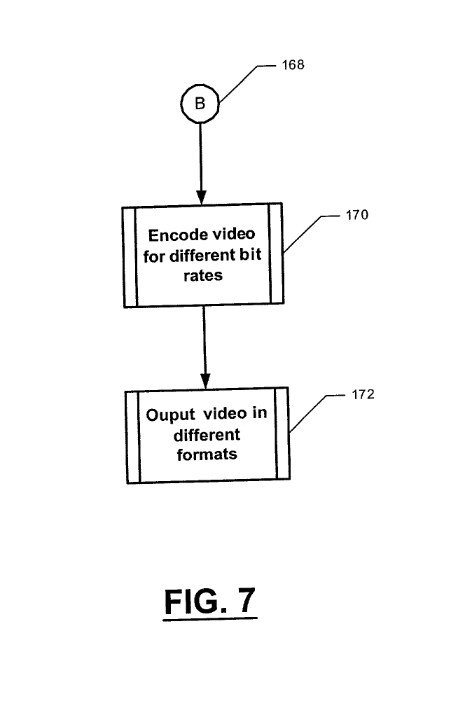

The script file with synchronization information is associated at step 166 with the uncompressed video file, such that the synchronization information becomes part of the video file (e.g., by use of ASF Indexer). Processing continues on FIG. 7 as shown by continuation indicator 168.

With reference to step 170 of FIG. 7, the final video file (uncompressed and with synchronization information) is encoded for different bit rates (56K, 120K, etc.). The final video file is output at step 172 in different formats (for Windows Media Player, Real Player, QuickTime, etc.)

The system and method described herein have the ability of completely hiding all signs of a media player, making integration of video onto a web page as seamless as possible. It also allows the video to become a fully interactive element on a web page. The technology also provides:(i) allowing video to be an integrated, rather than disjointed, element on a web page; (ii) giving web page designers a much wider range of creative flexibility in using video on web pages; (iii) allowing for a video response, rather than just a data response, to user interactions with the web page (because the video portion is seamless, it can give a more “human” feel to a web site); (iv) making it viable to have a human “guide/host” to help users navigate a web site this prevents having to guess at whether data or other elements will make navigation clear, and a human guide should make for a more pleasant, and more efficient means of navigating a complex, multi-page web site; (v) turning what was a two dimensional static web page into a three dimensional interactive environment; (vi) creating an environment more likely to engage a viewer, and thus to get the viewer to spend more time on the web site.

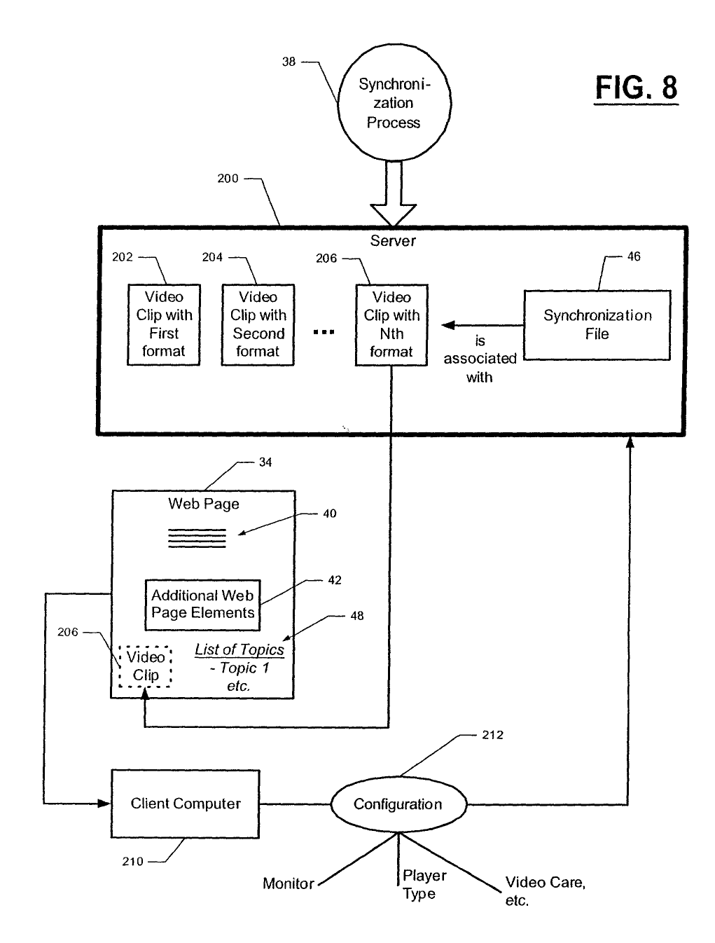

Having described in detail the preferred embodiments of the present invention, including the preferred methods of operation, it is to be understood that this operation could be carried out with different elements and steps. This preferred embodiment is presented only by way of example and is not meant to limit the scope of the present invention which is defined by the following claims. As an example of the wide scope of the present invention and as shown in FIG. 8, the present invention is adaptable to a number of media formats, synchronization techniques as well as adaptable to make it to work with a wider range of video cards. For example, the system and method is extensible to operate with Real and Windows media at a wider range of monitor pixel depths as well as on different types of monitors. The synchronization process generates video clips 202, 204, and 206 with different formats. A server computer 200 stores the video clips 202, 204, and 206 and has associated with each one the synchronization file 46. Based upon the configuration 212 of the client computer 210 that is displaying the web page 34, the server 200 provides the video clip that is best tailored to operate within the configuration 212 of the client computer. The server computer 200 uses many different configuration characteristics in making its video clip selection, such as the monitor type, player type, and video card type. In this way, the user of the client computer 210 is able to view video clips that best operate on her platform.

It is claimed:

1. A computer-implemented method for integrating video data with a document object that includes document elements, comprising the steps of:
(a) synchronizing the video data with at least one of the document elements so as to form at least one synchronization association, said synchronization association interrelating an activity of the video data with an activity of the document object;
(b) generating a synchronization file that includes the synchronization association; and
(c) associating the synchronization file with the video data so that the activity involving the video data appears on a computer-human display as integrated with the document object through the use of the synchronization association.

2. The method of claim 1 wherein the document object is a web page, wherein the synchronization file associated with the video clip allows the activity involving the video data to appear on the computer-human display as integrated with the web page.

3. The method of claim 2 wherein the document object is a web page that contains a background, wherein the synchronization file associated with the video clip allows the activity involving the video data to appear on the computer-human display as integrated with the web page's background.

4. The method of claim 3 wherein the web page's background is a virtual web page background.

5. The method of claim 3 wherein the web page's background is a real web page background.

6. The method of claim 1 wherein the document object is a web page, wherein the video data is integrated into a web page in such a way that extraneous background of the web page is substantially hidden from view while the video data is played on the computer-human display.

7. The method of claim 1 wherein the document object is a web page, wherein the video data is integrated into a web page in such a way that a media player running the video data is substantially hidden from view while the video data is played on the computer-human display.

8. The method of claim 1 wherein the document object is a web page, wherein the video data is integrated into a web page in such a way that a media player running the video data is completely hidden from view while the video data is played on the computer-human display.

9. The method of claim 1 wherein the document object is a web page, wherein the synchronization association allows the activity involving the video to be activated based upon the activity associated with the document object.

10. The method of claim 9 wherein the activity associated with the web page is selection of a line of text appearing on the web page, wherein the synchronization association allows the activity involving the video to be activated based upon the selection of the line of text.

11. The method of claim 1 wherein the document object is a web page, wherein the synchronization association allows the activity involving the web page to be activated based upon the activity associated with the video data.

12. The method of claim 11 wherein the activity associated with the video data is the video data reaching a preselected time during playing of the video data, wherein the synchronization association allows the activity involving the web page to be activated based upon the activity associated with the video data.

13. The method of claim 12 wherein the activity involving the web page is a display of at least one line of text.

14. The method of claim 13 further comprising the steps of:
synchronizing the video data with a second web page element so as to form a second synchronization association,
said second synchronization association interrelating a second activity of the video data with a second activity of the web page, wherein the synchronization file includes the second synchronization association,
wherein the second association activity associated with the video data is the video data reaching a second preselected time during playing of the video data, wherein the second synchronization association allows the second activity involving the web page to be activated based upon the second activity associated with the video data.

15. The method of claim 14 wherein the second activity involving the web page is a display of a second line of text.

16. The method of claim 1 wherein the document object is a web page, said method further comprising the step of:
preprocessing the video data before the video is synchronized at said step (a).

17. The method of claim 16 wherein the preprocessing of the video data includes preprocessing the video data through a chromakey process to remove a colored screen background and replace it with the web page's background.

18. The method of claim 17 wherein the preprocessing of the video data includes the video data being cropped and resized.

19. The method of claim 18 wherein the preprocessing of the video data includes compressing the video data, and using the compressed video data in the synchronizing of the video data with a document element during said step (a).

20. The method of claim 19 wherein the preprocessing of the video data includes using the video data in an uncompressed format so that quality adjustments to the video data may be performed.

21. The method of claim 20 wherein the synchronization file is associated with the video data in an uncompressed format such that the synchronization association within the synchronization file becomes part of the file that contains the video data.

22. The method of claim 1 wherein the video data is formatted to be played on the computer-human display through a multi-media video player.

23. The method of claim 1 wherein a client computer is hosting the document object, wherein a video clip is selected from a plurality of video clips having differing formats, said selection being based upon the client computer's configuration, said selected video clip being provided along with the associated synchronization file to the client computer so that the video clip may be played on the client computer.
